(19) United States
(12) Patent Application Publication
(10) Pub. No.: US 2010/0032332 A1
(43) Pub. Date: Feb. 11, 2010

(54) Portable Security Container with Tilt and Movement Detection System

(75) Inventors: Barrie William Davis, South Brisbane (AU); Benjamin John Davis, Fortitude Valley (AU); Matthew Kai Davis, Fortitude Valley (AU)

Correspondence Address: FULBRIGHT & JAWORSKI L.L.P., 600 CONGRESS AVE., SUITE 2400, AUSTIN, TX, 78701, US

(73) Assignee: XITEL PTY. LTD., South Brisbane (AU)

(21) Appl. No.: 12/537,825

(22) Filed: Aug. 7, 2009

Related U.S. Application Data
(60) Provisional application No. 61/087,175, filed on Aug. 8, 2008.

(51) Int. Cl. B65D 79/02; G08B 21/00; B65D 55/02

(52) U.S. Cl. 206/459.1; 340/669; 109/39

(57) ABSTRACT

A device and method for protecting personal property. The device includes a tilt and movement detection system utilizing acceleration due to gravity and an alarm adapted to signal when the device has tilted or moved beyond a predetermined position from a reference point.

### CROSS-REFERENCE TO RELATED APPLICATIONS

This application claims the benefit of U.S. Provisional Application No. 61/087,175, filed Aug. 8, 2008, entitled “Portable Security Container With Movement Detection System,” the entire contents of which is incorporated by reference herein.

### FIELD OF THE INVENTION

The present invention relates to improvements in devices designed to protect personal portable property such as mobile phones, music players, keys, wallets, purses, laptop computers, guns, GPS systems, money, documents and other similar personal items which can be quickly and easily stolen.

### BACKGROUND OF THE INVENTION

In recent times the value of personal belongings carried by most people in their day to day business has increased significantly. As well as the replacement cost of devices such as mobile phones, music players etc., there is also the additional cost of losing or having to replace phone numbers, photographs, music etc., which are held in the portable devices. Most people understand that having one of these devices stolen or misplaced will be a significant inconvenience in addition to the financial cost of buying a replacement. In the case of a laptop computer or other device capable of storing personal data, the replacement cost of the device may be insignificant compared to the value of the information saved therein.

In addition to the personal electronic devices, loss of other more fundamental items people carry on their person such as house keys, car keys, wallets, credit cards, passports, etc., can have a significant impact if they are stolen.

One way to protect these personal items is to place them in a secure environment. However on many occasions this is not possible. At the beach, gymnasium, living in a dormitory, or even just leaving a work space for a short time, exposes personal property to theft. Lockers, desk drawers, cupboards etc. provide some protection, but in most cases can be easily forced open or defeated in some other manner. When this happens, there is no alarm event to alert others the theft is occurring, which is why the loss of personal property in these situations is so prevalent.

Recent statistics indicate that of the total university dormitory population of the USA, about 25% will experience one personal theft a year. When extrapolated across the country to include country clubs, sports facilities, factory/office locker rooms, office desks etc., the level of personal theft is high and increasing. This is especially so for personal electronic devices which are now so wide spread that it is almost impossible to identify a specific unit as one's own once it has been stolen.

There are any number of devices which will detect the occurrence of motion and provide an alarm when they are moved. Most, if not all of these devices rely on the detection of motion in some way or another. They commonly rely on the motion of an attached object to cause a mechanical motion of part of the device which is then detected and an alert provided. Examples are mercury switch relays, moving pin mechanisms and ball race devices where the movement of an object causes a secondary motion within the detection device, which causes an alarm event.

A problem in detecting the motion of an object as the necessary event to cause an alarm condition is that motion in itself is not necessarily a sufficient condition for an alarm event. For example, if an object is accidentally knocked, it will experience motion even though it may not be subject to continual movement which involves the change in the position or location of something. If the movement of an object is to be the cause for an alarm event, then this condition may be accidentally satisfied and result in a false alarm if only the occurrence of motion is recognized.

### SUMMARY OF THE INVENTION

In one preferred aspect, the present invention is a portable light weight container which can be locked by means of a combination lock to secure any items placed inside. To prevent the locked container from being moved to a location where it could be forced open without attracting attention, a tilt and movement detection system is incorporated into the lid of the container. An audible alarm is also provided so that when the container is tilted or rotated around one or more of its axis or moved in any three dimensional direction from an initial reference position, the alarm is activated.

In a preferred aspect, the present invention is able to determine if it is being moved and/or tilted and may be adapted to determine if the movement and/or tilt is a hostile event in which case an audible alarm is sounded.

The present invention preferably provides protection against the theft of personal valuable items in several ways which work in unison to provide a comprehensive theft prevention method.

### BRIEF DESCRIPTION OF THE FIGURES

FIG. 1 is a perspective view of a security container with tilt and movement detection system in accordance with a preferred embodiment of the present invention.

FIG. 2 is an exploded view of the container of FIG. 1.

FIG. 3 is an enlarged view of the tilt and movement detection system of the container of FIG. 1.

FIG. 4 is a diagram of the tilt and movement detection system of FIG. 3.

FIG. 5 is a diagram showing an electrical overview of the tilt and movement detection system of FIG. 3.

FIG. 6 is an electrical diagram showing a microprocessor of the tilt and movement detection system of FIG. 3.

FIG. 7 is an electrical diagram showing an accelerometer of the tilt and movement detection system of FIG. 3.

FIG. 8 is an electrical diagram showing an alarm of the tilt and movement detection system of FIG. 3.

FIG. 9 is a perspective view of the tilt and movement detection system in accordance with another preferred embodiment of the present invention, sized to be able to contain a laptop computer.

FIGS. 10 to 16 are flow diagrams showing an operation of the tilt and movement detection system in accordance with another preferred embodiment of the present invention.

### DETAILED DESCRIPTION OF THE ILLUSTRATIVE EMBODIMENTS

Alternative embodiments of the invention will be apparent to those skilled in the art from consideration of the specification and practice of the invention disclosed herein. It is intended that the specification and examples be considered as exemplary only, with a true scope and spirit of the invention being indicated by the claims which follow.

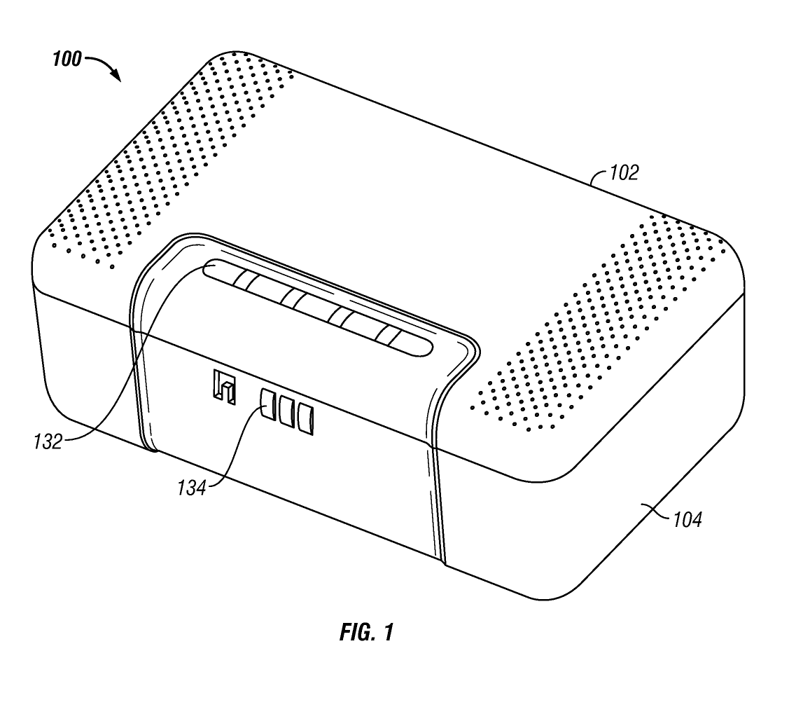

FIGS. 1 to 4 show a preferred embodiment of a security container 100 having a lid 102, a base 104 and a tilt and movement detection system 106. The preferred elements of container 100 and their interrelationship are described below.

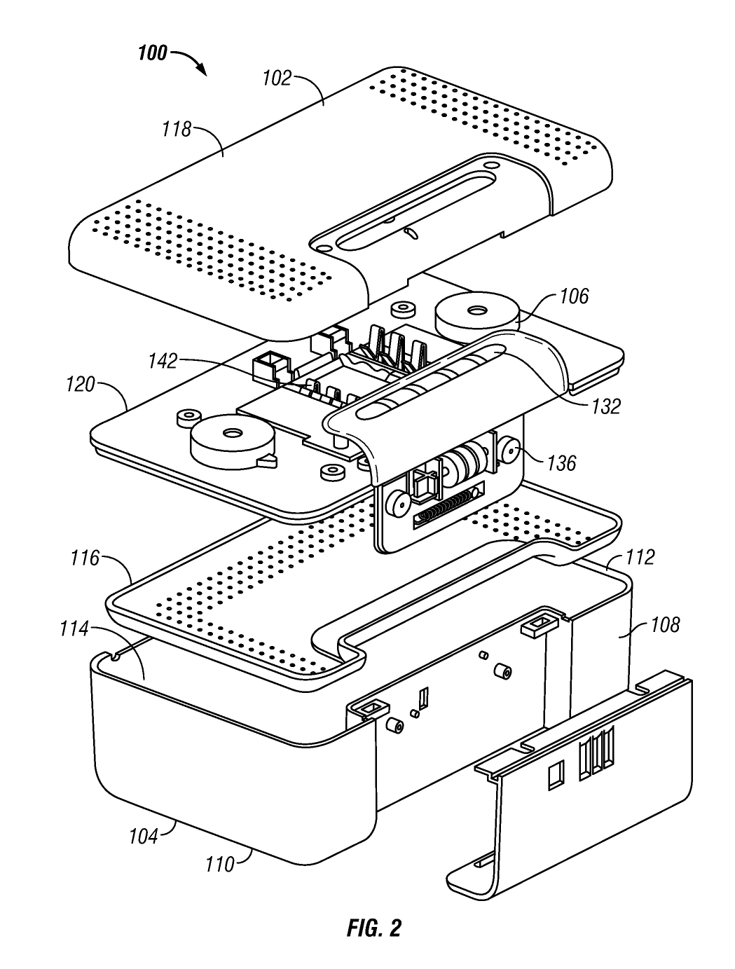

Referring to FIGS. 1 and 2, container 100 includes a front 108, sides 110, 112 and an interior 114. Interior 114 preferably is sized and configured to receive a removable bottom tray 116. As shown in FIG. 2, lid 102 preferably includes a top cover 118 and a base cover 120 on which is at least a portion of tilt and movement detection system 106.

As shown in FIGS. 2 to 4, tilt and movement detection system 106 preferably includes an electronics assembly having a tilt and movement detector 122, a controller 124, an alarm 126 and an arming mechanism 128. Each of these components are discussed in further detail below.

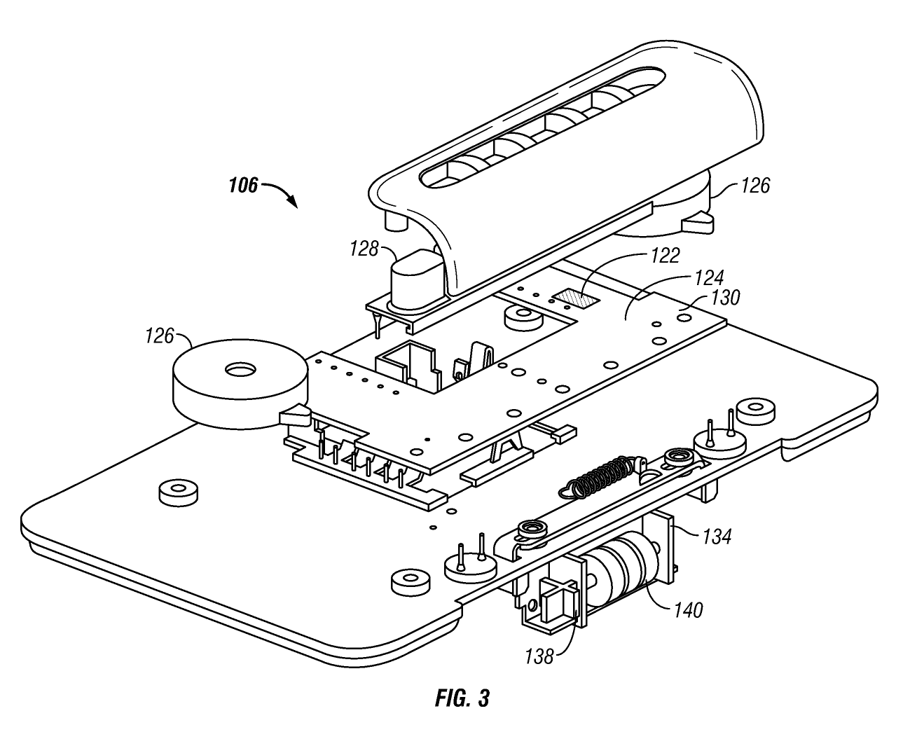

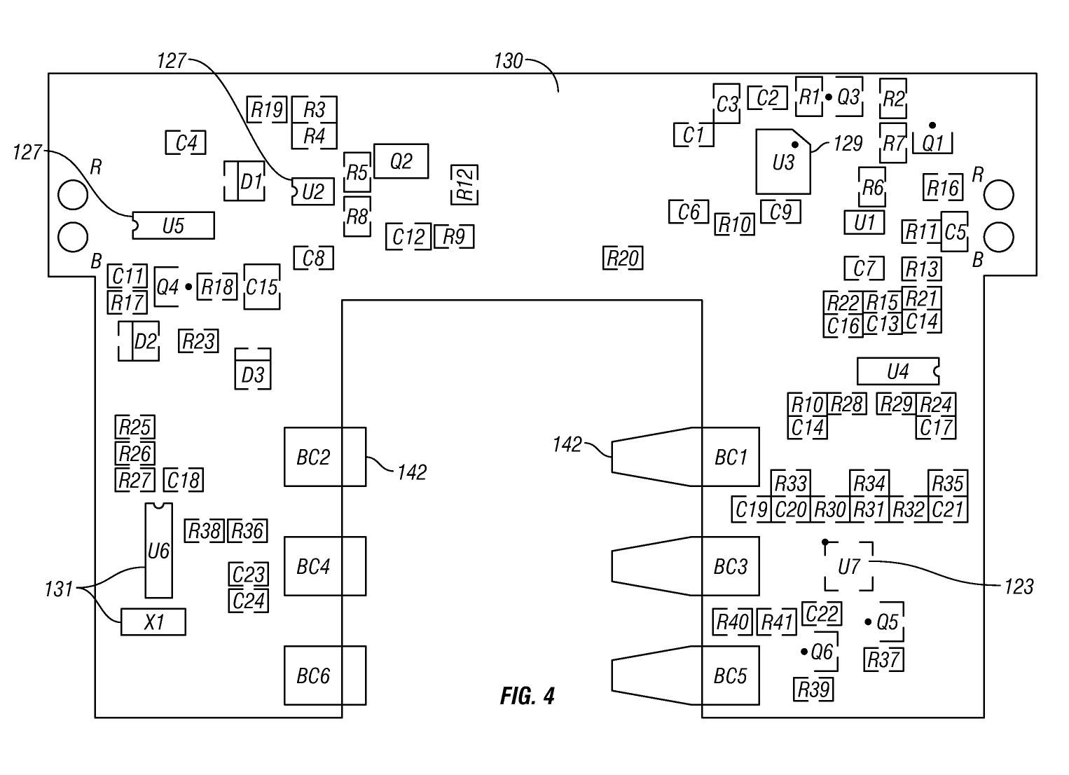

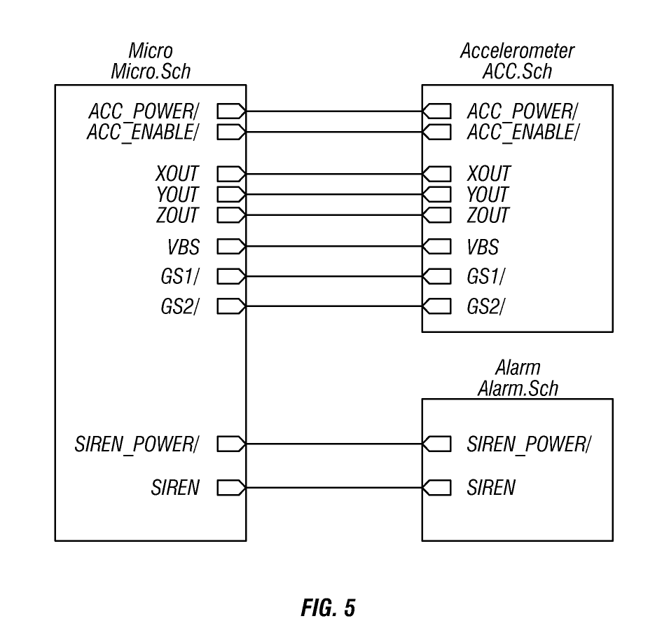

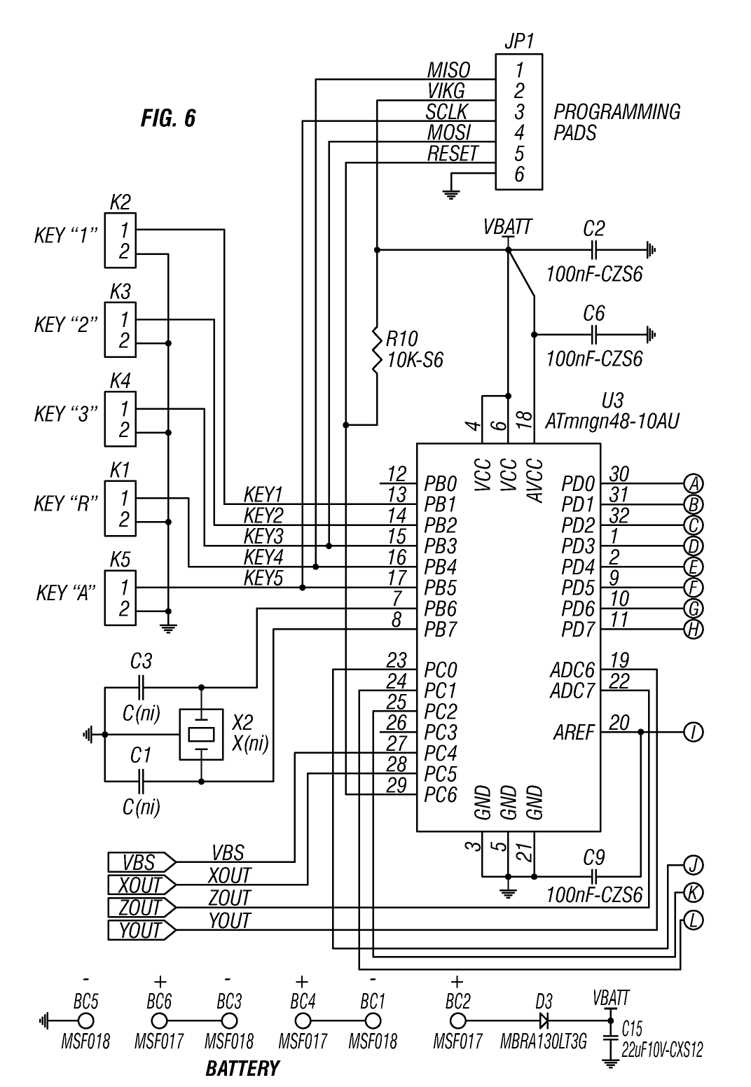

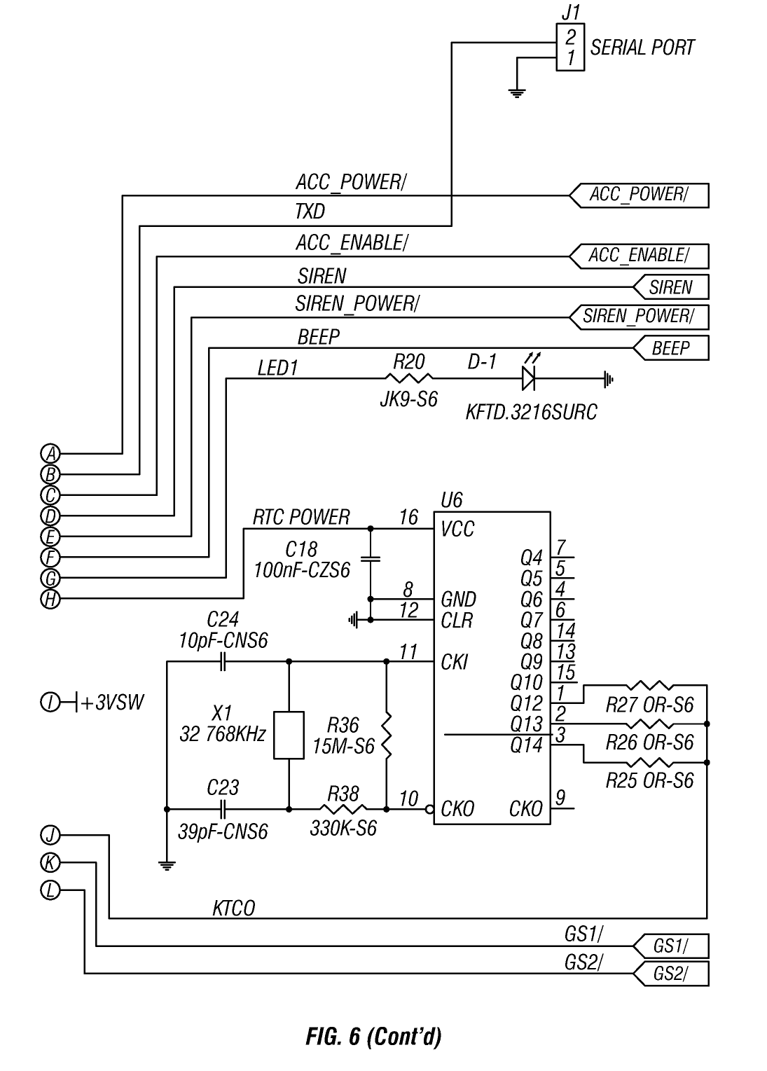

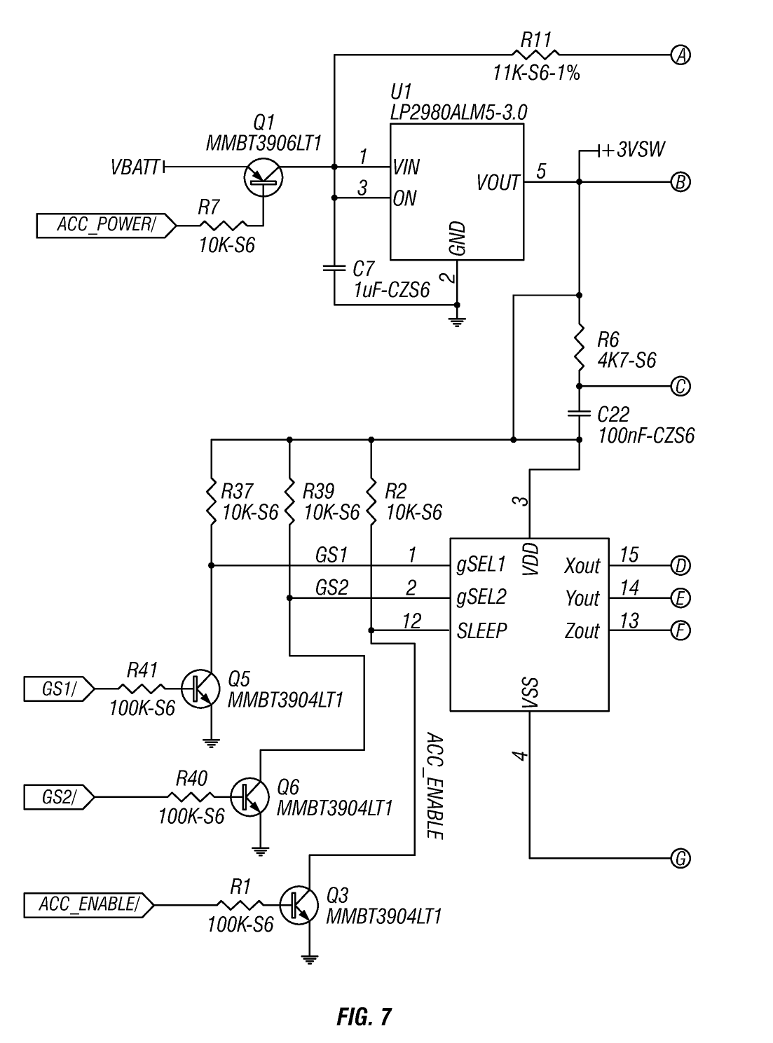

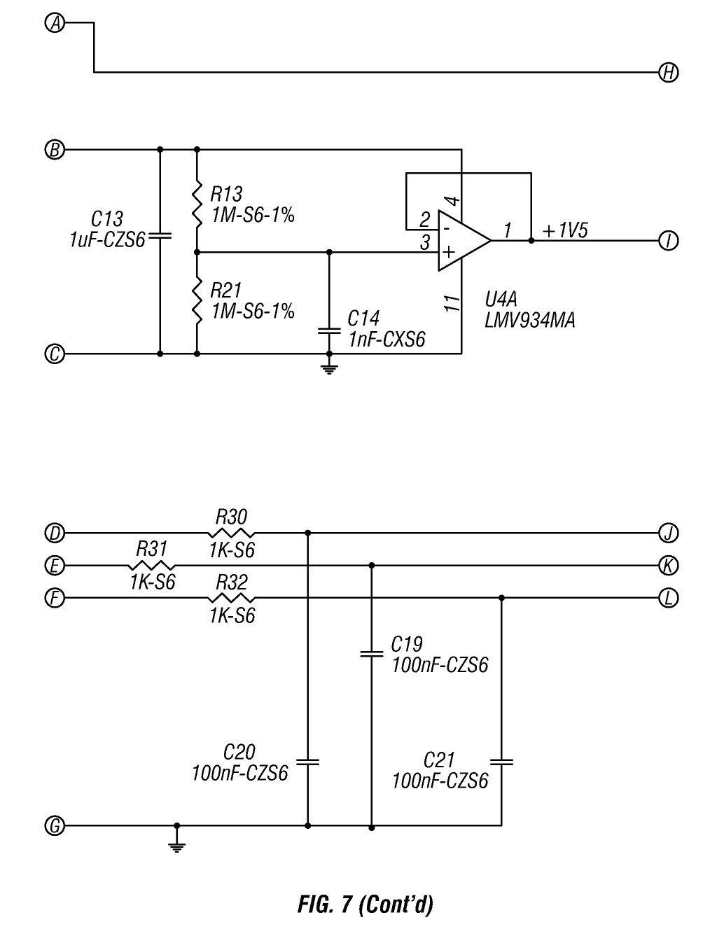

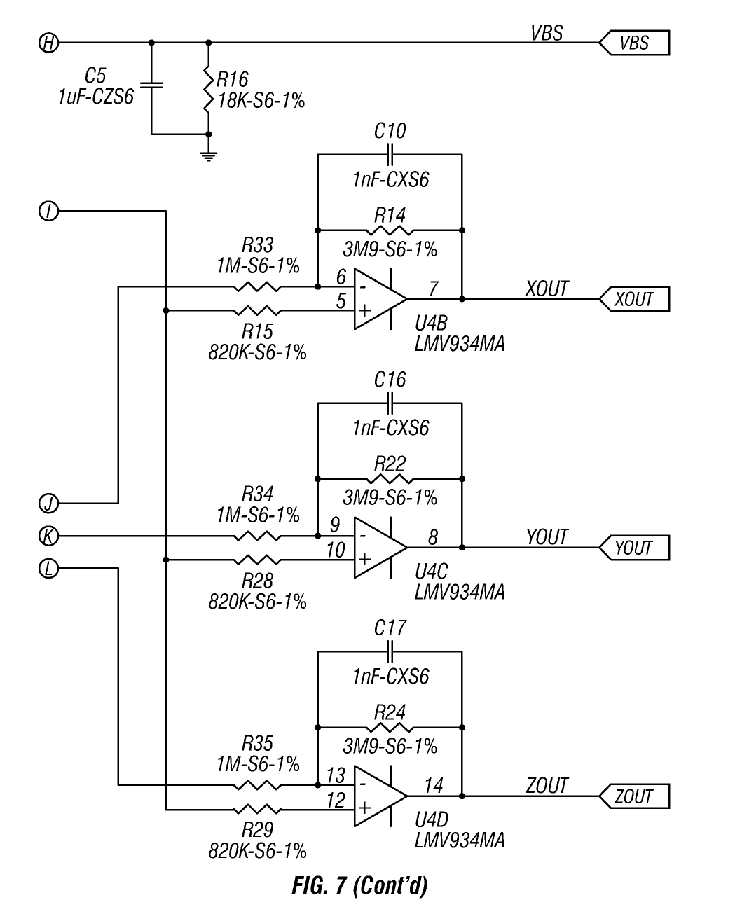

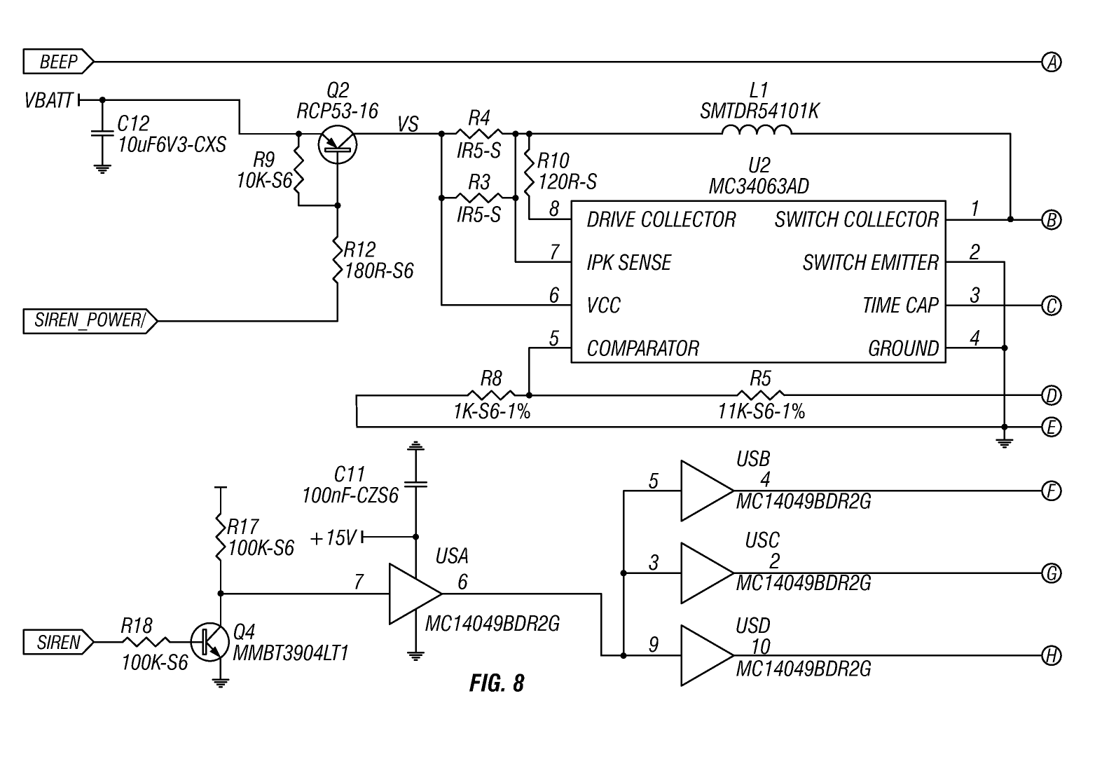

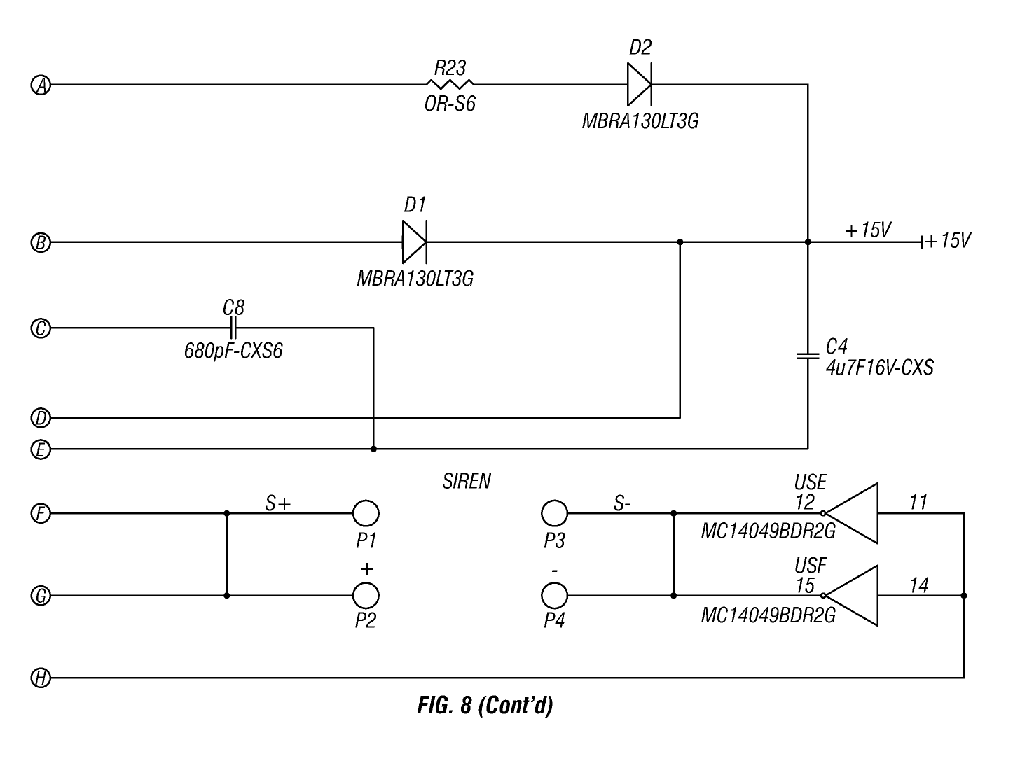

Referring to FIGS. 3 and 4, tilt and movement detector 122 is preferably formed as an accelerometer 123. The accelerometer is preferably a MEMS three-axis, low gravity analogue output acceleration sensor which provides its own instantaneous acceleration relative to the acceleration of the earth's gravity of 1 g, the acceleration when the accelerometer is at rest. The outputs of the accelerometer are preferably three analogue signals, one each for the individual acceleration relative to the earth's gravity in the X axis, Y axis and Z axis coordinates of three dimensional space.

Referring to FIGS. 3 and 4, the accelerometer 123 may also be a MEMS three-axis low gravity digital output acceleration sensor which provides its own instantaneous acceleration relative to the earth's gravity of 1 g, the acceleration of the accelerometer at rest. The digital output of the accelerometer may be one of several standard serial protocols such as the PC or SPI synchronous serial digital communications methods. The associated protocol format allows the accelerometer to be controlled by a controller 124 allowing the individual accelerations relative to earth's gravity in the X axis, Y axis and Z axis coordinates of three dimensional space to be accessed.

When accelerometer 123 is at rest and one axis is aligned with the centre of the earth, the analogue signal for that axis will represent 1 g, the acceleration due to the earth's gravity. The analogue signal outputs for the other two axes will be zero. When accelerometer 123 does not have an axis aligned with the centre of the earth, each axis output will have a non-zero analogue signal output which will again represent the acceleration due to the earth's gravity of 1 g. When accelerometer 123 is moved, the analogue signal outputs preferably change from the “at rest” values and will represent the acceleration of the accelerometer as it moves through three dimensional space relative to the “at rest” values which represent the earth's acceleration of 1 g.

The system may include a gyroscope if desired. Incorporation of a gyroscope allows the angular momentum in terms of the container's pitch, and/or roll and/or yaw to be determined which can be used to enhance the accuracy when determining the position of the container. The system may include a magnetometer if desired. Incorporation of a magnetometer allows the direction and magnitude of the earth's magnetic field to be determined which can be used to enhance the accuracy when determining the position of the container.

Referring to FIGS. 3 and 4, controller 124 is preferably formed as a single chip microcontroller 129 having a printed circuit board 130, although a multiple chip microcontroller can equally be used if desired. Microcontroller 129 receives the acceleration information in analogue format from accelerometer 123 via the X axis, Y axis and Z axis signal outputs of the accelerometer. Because the value of the acceleration is preferably represented as three electrical analogue voltages, it is usually necessary to convert the analogue signal value to a digital value to allow the acceleration information to be processed by the mathematical algorithms executed by microcontroller 129. Preferably the microcontroller incorporates an Analogue to Digital (A/D) conversion functional unit, although an external A/D could also be used. It is envisaged that the A/D function may form a portion of the accelerometer if desired. It will be appreciated that accelerometer 123 may provide values in digital format and that microcontroller 129 may have a digital chip to eliminate any need for an A/D conversion. Microcontroller 129 preferably includes a real time clock 131.

In a preferred embodiment, the present invention uses a MEMS three axis accelerometer to measure the acceleration of the force of gravity (g) and the acceleration caused by the motion of the invention. The ability to be able to measure changes in both tilt (orientation) and movement (motion) significantly increases the ability to determine a hostile event over methods that only measure motion.

Motion along a single axis will result in an acceleration vector for that axis only. If the acceleration is very low, which is the case when the motion is very slow, it may be less than the resolution of the accelerometer. Motion along two axes will result in two acceleration vectors and motion along all three axes will result in the corresponding three acceleration vectors. However, even though a three axis accelerometer can provide additional sensitivity if the motion is two or three dimensional, the acceleration associated with the motion still has to be greater than the resolution of the accelerometer before it can be determined.

In a preferred embodiment of the present invention, the sensitivity to a hostile event is further enhanced by measuring any changes in the tilt or orientation of the system as well as movement or motion of the system. To do this, the system preferably considers the acceleration due to the force of gravity on the object being monitored as well as the acceleration of the object due to motion.

When the system is armed and stationary, there is no acceleration associated with movement of the object, so any acceleration readings provided by the accelerometer are due to the force of gravity which can be considered a constant of 1 g for this application. If one axis of the three axis accelerometer is aligned with the force of gravity, it will provide an accelerometer reading for that axis of 1 g, while the other two axes will have an accelerometer reading of 0 g each. In other orientations, the accelerometer readings for each axis will change in relation to their angular position to the direction of the force of gravity, but at all times the sum of the readings of the three axes will be 1 g.

Unlike motion which can be along a single axis of the accelerometer, if the orientation or tilt of the object being monitored changes, it will result in the change of the effect of the force of gravity on at least two axes of a three axis accelerometer. Because the force of gravity is constant, the rate of change of the orientation or tilt of the object is not a factor and as soon as the change in the angle of tilt is such that the resolution of the accelerometer is exceeded, the accelerometer readings will change on at least two axes, which can be determined as a hostile event.

When a hostile event occurs, it is most usually due to the object that is being monitored being picked up and carried away. In this event, the combined effects of acceleration due to orientation and motion will occur and it is a preferred ability of the present invention to be able to measure and interpret this complex effect that increases its sensitivity in determining the occurrence of a hostile event over methods which rely on motion alone.

Microcontroller 129 preferably has a non-volatile, read-only memory that provides the program storage for the mathematical, logical and decision making algorithms. Microcontroller 129 preferably has a read-write memory which may be volatile, that provides temporary storage for the results of calculations. Microcontroller 129 preferably has an interrupt system which may be used by the real time clock and an input means, described further below, to activate the tilt and movement detection system if it is in a power down or sleep mode.

Real time clock 131 is preferably an independent timing circuit which can be started and stopped by microcontroller 129. It is preferably connected to the microcontroller's interrupt system and is used by microcontroller 129 to provide a “wake up” signal when in a sleep mode. To conserve battery power, microcontroller 129 can activate real time clock 131 and then change to its sleep mode. At a predetermined time, real time clock 131 will activate the microcontroller's interrupt system and cause microcontroller 129 to “wake up” to monitor mode to check the status of the tilt and movement detection system.

Referring to FIG. 3, alarm 126 is preferably an audible alarm, more preferably a piezo audio transducer unit which can provide in excess of 80 dB of audible sound from a physically small, low power device. The audible alarm may be used in conjunction with an LED indicator to provide audio and visual feedback to the user on the status of system 106 during the entry of the security code and the arming and disarming operations, described further below. The piezo audio transducer is preferably driven by a switching H-bridge amplifier which provides an optimum 30 volts peak-peak signal from a 15 volt power supply derived from a primary 4.5 volt battery power system. Alarm 126 is preferably driven by drivers 127 (FIG. 4). It will be appreciated that the piezo audio transducer can also be driven from an auto transformer to provide the required voltage.

It will be appreciated that the real time clock 131 can be incorporated into the microcontroller 129, but this method may consume additional battery power to the external real time clock method.

As shown in FIGS. 1 and 2, arming mechanism 128 preferably includes a keypad 132 having preferably five keys as the interface between a user and the microcontroller. Keypad 132 is preferably used to: arm the system; disarm the system; and reset the system if a mistake is made when entering a user command.

Keypad Layout

| | | | | |
|---|---|---|---|---|
| A | 1 | 2 | 3 | D |

As shown above, keypad 132 preferably includes five keys or buttons in one row. The keys are preferably annotated A (Arm), the numbers one (1), two (2), and three (3) and D (Disarm). The five keys are preferably used in conjunction with each other to: select a motion sensitivity program; enter the security code; arm the system which activates tilt and movement detection; disarm the system which suspends tilt and movement detection.

The preferred functions of the individual keys are: number keys 1, 2, and 3—used to enter a four to six number security code into the system; Alpha key A—the first and last character of an arm sequence; and Alpha key D—the first and last character of a disarm sequence. It will be appreciated that the keys may be differently configured if desired. For example, instead of “A” and “D” keys, symbols showing a padlock in the locked or unlocked position may be used as desired.

Keypad 132 preferably connects directly to the microcontroller interrupt system and pressing the arm or disarm key preferably causes the microcontroller to power up from sleep mode and bring system 106 into a monitor mode, its active mode of operation.

As shown in FIGS. 2 and 3, container 100 preferably includes a lock 134, which is preferably a combination lock. Lock 134 preferably includes a mounting boss and lock plate slide guide 136, a lock plate knob 138 and a combination element 140. The combination lock is preferably a three-rotor mechanism with each rotor preferably having ten positions, which provide an adequate number of unique settings to thwart most attempts to guess the correct combination. Other combinations of rotors and rotor positions can be used if required. Alternatively, a mechanical lock and key can be used instead of a combination lock.

Referring to FIG. 2, tilt and movement detection system 106 is preferably powered by batteries insertable into battery clips 142. The piezo audio alarm provides its loudest audio output when it is driven by a 30 volt peak-peak signal while the rest of the electronics circuits require from 3 to 5 volts DC. Primary power is preferably provided by three AAA batteries, preferably the Alkaline type, which when connected in series, provide a terminal voltage of approximately 4.5 volts fully charged. The batteries preferably provide the power to the low voltage electronic circuits directly through electronic series regulators. The relative high voltage 15 volt power supply for the piezo audio alarm is derived from the batteries preferably by means of a DC/DC convertor which is only activated when the alarm is operating. At all other times it is preferably deactivated to conserve battery power.

Container 100 may be constructed from a variety of materials. For example only, the body of container 100 may be made of high impact resistant plastic (ABS, PC or other similar materials) or metal and is preferably relatively light weight. The container may be formed from a flexible material such as a cloth or soft sleeve if desired. A cloth material is more light-weight than many other materials. The cloth material may include one or more fibres of a material more resistant to breakage than the cloth to permit the cloth sleeve to be substantially tamper-proof when attacked by a sharp object such as a knife. For example, the cloth may include one or more ceramic or metal fibres interwoven into fabric.

Having described the preferred components of the security container, a preferred method of use will now be described with reference to FIGS. 1 to 4.

To initialize tilt and movement detection system 106, preferably a user security code is entered. Once the security code has been accepted, preferably the same four to six digit numeric sequence may be used to arm or disarm the system. To initialize the system, the user preferably presses and holds the arm and disarm keys at the same time until the monitor light turns on. The old code is entered and then the user presses the disarm key. The system will beep once and the monitor light will start flashing. The new 4 to 6 digit code is entered and the user presses the arm key. The system will beep twice. The user enters the new 4 to 6 digit code again and presses the arm key. The system will beep twice and the monitor light will stop flashing. This indicates that the new code has been saved into memory.

If the system beeps one long beep and the monitor light stops flashing, it means an entry error has been detected and the complete security code sequence needs to be started again by releasing and then pressing and holding the arm and disarm keys down at the same time to begin another security code initialisation sequence.

The user can reset the security code at any time the system is disarmed by holding the arm and disarm keys down at the same time and then repeating the initialization procedure. Once the security code has been entered and accepted the system can be armed and disarmed as required by the user.

To arm the system, the user preferably presses the arm key followed by the security code's four to six digit numeric sequence and then presses the arm key a second time to complete the arm function. As soon as the arm key is pressed, microcontroller 129 changes from sleep mode to monitor mode and monitors keypad 132 for the entry of the arm sequence. If an incorrect security code is entered or the user takes longer than the guard time to enter the arm sequence, a long beep is given and the arm function is terminated. At any time before the arm key is pressed a second time, the arm sequence can be terminated by pressing the disarm key. The system will respond with a long beep indicating it has recognized the termination of the arm sequence. Alternatively, if the arm sequence is discontinued, microcontroller 129 will preferably automatically terminate the arm sequence when the guard time expires.

When the arm key is pressed to initiate an arm sequence, the LED indicator is illuminated and remains on for the duration of the arm sequence.

If the arm sequence is accepted, the system gives two short beeps indicating the transition delay has commenced, which allows the user to position container 100 before monitoring begins. The system LED gives a short flash for each second of the transition delay. When the transition delay expires, the system gives another two short beeps before becoming armed, the LED indicator is turned off and the system enters its monitor mode.

Once system 106 is armed, it enters a monitor mode and preferably any movement is deemed to be a hostile event capable of activating alarm 126. If the system is already armed and a user starts to enter the arm sequence again, the system is preferably programmed to recognize this and suspend activation of the alarm pending a correct arming sequence being entered. If the correct arming sequence is entered, the system waits for a predetermined period of time before rearming. However, if the arming sequence is entered incorrectly, this is immediately deemed to be a hostile event. The system goes to an alarm mode and audible alarm 126 is activated.

Once system 106 has been armed, it changes from sleep mode to monitor mode where it is preferably continually checking to see if it has been tilted or moved from the initial reference point.

If lid 102 is positioned so that keypad 132 can be operated without moving container 100, the disarm sequence is similar to the arm sequence. In this situation, the user preferably presses the disarm key followed by the security code's four to six numeric sequence and then presses the disarm key a second time to complete the disarm function. If the disarm sequence is entered correctly, two short beeps are given after the disarm key is pressed the second time to complete the disarm sequence entry. The system then preferably reverts to sleep mode where the microcontroller powers the system down to its minimum operating power condition.

If the disarm sequence is not correct or takes longer than the guard time to enter, the system changes from monitor mode to a tamper mode. The disarming procedure required once the system is in tamper mode depends on which operating mode has been set by the user. Preferably the invention can be set to one of three operating modes which determine the latitude available to disarm system 106 once the system changes to tamper mode.

In a preferred embodiment of the invention there are at least three operating modes which are:

Instant Mode
As soon as system 106 determines it has moved and/or has been tilted, the alarm condition is activated.

Delayed Mode
System 106 uses the same movement and/or tilt criterion as instant mode except the alarm condition is delayed by 5 seconds. If the disarm key is pressed during the 5 second delay period the system reverts to the disarm sequence. If the disarm key is not pressed during the 5 second delay period, the alarm condition is activated.

Timed Mode
System 106 uses the same movement and/or tilt criteria as instant mode except the alarm condition and motion/tilt monitoring are suspended for 3 seconds. After the 3 second interval from the time motion/tilt was first determined, the system's acceleration is again tested with the instant mode criteria and if it is being moved (motion and/or tilt) the alarm condition is activated. If the system is not being moved, normal monitoring is resumed.

To prevent repeated attempts to disarm the system from occurring when the system is in monitor mode, controller 124 preferably automatically interprets a keypad entry as a potential hostile event. If the first number entered is correct, the microcontroller reverts to the normal disarm mode. If the first number or any subsequent numbers entered are incorrect, instead of entering the alarm mode as for disarming after a hostile event, the system waits for a) the guard time to expire or b) the maximum number of numbers to be entered or c) the disarm key to be pressed at which time a hostile event is determined and the alarm 126 is activated. The incorrect entry of the disarm sequence once a keypad entry commences is preferably a sufficient condition to cause a hostile event even though the system tilt and/or movement limits have not been reached.

When system 106 determines that container 100 has moved and/or has been tilted, the system preferably registers the occurrence of a hostile event. However, the hostile event could be the result of the user moving the container in order to disarm it in the normal method of use. By providing preferably three operating modes the user is able to select one of these modes which best suits their usage pattern.

Once system 106 is in alarm mode, preferably the only way to disarm the system and cancel the alarm is to enter the disarm code sequence within a predetermined time. The number of attempts to enter the disarm code is not limited, however once the alarm condition is activated, alarm 126 will continue until the correct disarm code is entered.

If the alarm is cancelled with the correct disarm code, system 106 may be programmed to revert to a system idle mode. If the alarm is cancelled because another optional preset condition has been satisfied, the system will preferably revert to the arm mode.

System 106 preferably only changes to alarm mode if a hostile event is deemed to have occurred. As soon as the system enters alarm mode, it activates audible alarm 126 to alert the user and/or others that the container is being tampered with, or that the container has been tilted or moved from the initial reference point. Movement caused by an accidental bump or knock to the system is preferably normally not deemed to be a hostile event because the movement is of very short duration and, in most cases, will be determined as not being a hostile event.

Once system 106 is in alarm mode, it will preferably continue to activate audible alarm 126 until the correct disarm sequence is entered, movement ceases or some other optional preset condition is satisfied.

System 106 is preferably able to accurately measure its own tilt and/or movement relative to the initial reference. Once system 106 is in the alarm mode, its movement measuring capability in three dimensions preferably allows the system to discriminate between different hostile events and take the appropriate action relative to each event. Examples of such events include, but are not limited to: (1) the container is moving; the alarm remains active as long as the container is being moved; and/or (2) the container has stopped moving; the alarm remains active for 10 seconds after the movement ceases.

If container 100 remains stationary, the three signal outputs of the accelerometer will show the system is being subjected to an acceleration of 1 g. A force needs to be applied to the container to move it. As soon as this occurs, the accelerometer signals will change and the microcontroller of controller 124 will determine that tilt or motion of the container is occurring.

To discriminate between accidental movements or bumps and movements which are due to a hostile event, the duration that the acceleration of the container exceeds the threshold value may be used as a second and necessary condition to determine a hostile event has occurred. In this case an accidental bump of the container will cause an acceleration on one or more of the X axis, Y axis or Z axis which exceeds the threshold value for a hostile event. The controller 124 algorithms may discriminate such an event is due to an impulse occurrence such as a bump or knock and allow false alarm conditions to be minimised.

It will be appreciated that the steps described above may be performed in a different order, varied, or omitted entirely without departing from the scope of the present invention.

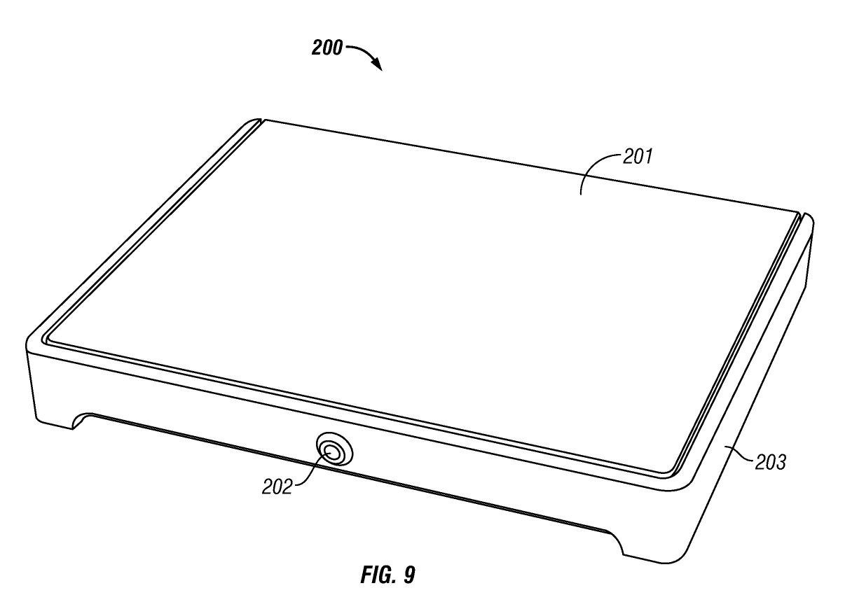

Referring now to FIG. 9, a semi portable container 200 is shown in accordance with another preferred embodiment of the present invention. Unit 200 is similar to container 100 already described except that Unit 200 is preferably configured so that it is able to contain a laptop computer.

Unit 200 preferably includes an outer case constructed of steel which has a protective plastic dressing 203. The plastic dressing attaches to the outer sides of the steel case, and provides additional strength to the steel case 200.

The plastic dressing 203 also extends into the front of case 200 to provide a protective support. In addition, internal soft dressings which attach to the steel case 200, but not shown, provide protection to the laptop computer.

A hinged lid 201 is held shut by a high security key lock 202 and when closed securely contains a laptop computer inside the container.

The front section of the case 200 preferably contains the same tilt and movement detector and alarm system as is used in the lid described above in relation to container 100. Preferably instead of a keypad similar to the keypad 132 of container 100, the tilt and movement detector and alarm system of container 200 are activated and de-activated by a key lock 202.

Preferably when hinged lid 201 is open, an Arm/Disarm switch is accessible allowing the tilt and movement detector and alarm system to be enabled or disabled. When the Arm/Disarm switch is set to Arm locking the hinged lid 201 of container 200 with key lock 202 activates the tilt and movement detector and alarm system. Unlocking the hinged door 201 with key lock 202 deactivates the motion detection and alarm system allowing a laptop computer to be placed inside or removed from container 200. When the Arm/Disarm switch is set to Disarm, the tilt and movement detector and alarm system is de-activated, but a laptop computer can still be secured inside container 200 by locking hinged lid 201 with key lock 202.

Container 100 is light and portable so the accelerations on the X axis, Y axis and Z axis are significant and easily measured if the container is moved with the intention of theft. The size and weight of a portable plastic container presupposes an attempt to steal the contents will result in the entire container being moved with the view to opening it in another place.

It can be appreciated that the physical size of container 200 makes it less of a portable device than container 100. Being preferably constructed primarily of steel also increases its weight significantly so that it is unlikely container 200 will be used to carry a laptop computer from place to place. It is also apparent that from its physical shape and functional operation that in most cases it will be placed horizontally or vertically.

With container 200, because of its size, weight and contents, it is likely that a thief may consider attempting to open the container in situ and removing the laptop computer rather than taking the container and its contents to a different location.

In this situation, attempts to open container 200 will result in very low accelerations of the container which may not be measurable by the movement detection algorithms of the tilt and movement detection system as hostile events. However, the tilt and movement detection system of container 200 will analyse the effect of gravity on the accelerometer so that it can determine if container 200 has been tilted rather than moved. In this case it is not the acceleration of container 200 which is the determinate of a hostile event occurring, but the change in tilt of container 200 relative to its tilt at the reference position.

The acceleration of gravity is 1 g and is constant at 32 ft/sec². If the acceleration of container 200 is orientated so that at rest, the X axis and Y axis are subjected to an acceleration 0 g, the Z axis will be subjected to an acceleration of 1 g. If container 200 is rotated around the Y axis by 90 degrees, the X axis acceleration due to gravity will change from 0 g to 1 g and the Z axis will change from 1 g to 0 g. It can be seen that a 90 degree change in tilt can result in a large measurable change in acceleration due to gravity on one or more axes depending on the direction of tilt. At the same time the amount of acceleration due to the movement resulting in displacement of container 200 is small or zero.

As previously noted container 200 will in most instances be placed in a horizontal or vertical position. Its construction and weight preferably preclude it being placed at an angle to the horizontal or vertical. This means if the accelerometer is mounted in the same axis orientation as the expected position of container 200, the accelerometer readings of gravity on its X, Y and Z axes will be 0, 0, 1; or 0, 1, 0; or 1, 0, 0.

Preferably the acceleration readings from the accelerometer mounted in container 200 should provide a non-zero reading when in a rest position. This can be achieved by mounting the accelerometer at an angle to the X axis, Y axis and Z axis of container 200 so that when container 200 is in the horizontal or vertical position, each axis reading from the accelerometer will be a component of the acceleration due to gravity of 1 g. Changing the orientation of the accelerometer's acceleration due to motion or acceleration due to tilt will result in a change in the value of the accelerometer reading on all three axes.

### Example of the Operation of an Illustrative Embodiment of the Invention

In this embodiment, the necessary criteria when the system is Armed is it will remain stationary in the same position and orientation at the time of arming. If the system is moved (change of position) and/or tilted (change of orientation), these constitute necessary and sufficient changes for a hostile situation to be determined. If the system's acceleration is being is measured at regular intervals, it is only necessary to determine if the system's acceleration has changed from one successive sample to the next to be able to determine the system's motion and/or orientation has changed.

In this embodiment of the invention, the acceleration measurement parameters preferably are:
The basic system timing is generated by the real time clock (RTC) which generates an interrupt to the microcontroller 16 times per second or once every 62.5 msec.
The RTC interrupt causes the microcontroller to change from its Power Down mode to its Operating Mode.
The microcontroller counts the interrupts it receives from the RTC and every 500 msec or twice a second it measures the instantaneous acceleration values of the X, Y and Z axis of the accelerometer. This is called the basic sample rate or BSR.

Because the MEMS accelerometer is a mechanical/electronic device there is a certain very low level of random background noise which has to be removed to ensure the resultant measurement is accurate. One method of removing the background noise is to use an electronic low pass filter in the signal path between the accelerometer and the microcontroller, however this method also requires the time between successive samples to be extended.

In this embodiment of the system, a mathematical algorithm called a rolling averaging filter is preferably used by the microcontroller to remove the accelerometer background noise.
The rolling averaging filter sample period is 100 msec commencing every BSR time.
The number of X, Y and Z axis samples taken during the 100 msec rolling averaging filter sample period is 64 which are evenly spaced at 1.5625 msec intervals.

The accuracy of the measurements of the instantaneous values of the X, Y and Z axis acceleration of the accelerometer and the basic accuracy of the MEMS accelerometer itself preferably determine if the system is able to meet its criteria of being able to determine if it is being moved and/or tilted. It can be appreciated that those who may have an understanding of how a device such as the present invention is constructed could try to thwart its operation by moving the system in such a manner that the system's accuracy is compromised. However, the measurement techniques and algorithms incorporated in the system and described below provide a level of accuracy which exceeds the ability of most if not all humans to not create a hostile event when trying to move the system.

The system's accuracy is preferably determined by the following parameters:
The unsigned precision of the microcontroller's analogue to digital (A/D) Convertor is 10 bits. This provides a 1 bit resolution of 1/1024 or 0.000977 of the full scale range of measurement
The full scale range of the A/D convertor is 3 volts or 2.93 mV/count (excluding sampling errors).
The precision of the MEMS accelerometer used in this particular embodiment of the system preferably has a nominal resolution of 800 mV/g.
The empirical resolution of the A/D convertor and the filter algorithms is preferably 1 count or 3.66 mg
Each of the accelerometer acceleration outputs (X, Y and Z) provides a signal of approximately 1.5 volts when subjected to an acceleration of 0 g.

The operating parameters of this particular preferred embodiment of the invention include the following:
All acceleration measurements are relative to previous measurements so absolute position samples and initial condition zeroing or nulling is not required.
Determinations of motion and/or tilt are necessary and complete alarm conditions and it is not necessary to calculate the angle of tilt or the velocity and/or distance of movement of the system in this embodiment.
The change in the analogue output signal of any of the accelerometer x, y or z axis outputs can only be caused by:
   a. the system physically being moved, or
   b. the system being tilted, or
   c. the system being both moved and tilted.

Any change in the system's acceleration being measured by the accelerometer is a valid indication that the system has moved from its previous stationary position. This preferred embodiment of the invention preferably has three operating modes:

Instant Mode
As soon as the system is determined to have moved (motion) and/or tilted (orientation), the alarm condition is activated.

Delayed Mode
The same movement and/or tilt criterion as instant mode except the alarm condition is delayed by 5 seconds. If the disarm key is pressed during the 5 second delay period the system reverts to the disarm sequence. If the disarm key is not pressed during the 5 second delay period, the alarm condition is activated.

Timed Mode
The same movement and/or tilt criteria as instant mode except the alarm condition and motion/tilt monitoring are suspended for 3 seconds. After a 3 second interval from the time motion/tilt was first determined, the system's acceleration is tested with the instant mode criteria and if it is being moved (motion and/or tilt) the alarm condition is activated. If the system is not being moved, normal monitoring is resumed.

Preferred details of the operation of the rolling average filter algorithm are:
Spectrum analysis of the MEMS accelerometer type used in this embodiment of the invention which has an output low pass filter of 1 Kohm resistor and a 100 nF capacitor in series with each of the X, Y and Z axis outputs shows:
   a. The noise spectrum has approximately 15 positive and negative peaks over each 100 msec period.
   b. The amplitude of the peaks are approx ±10 mV with an occasional burst to ±20 mV which last for approx 30 msec.
   c. Empirical tests indicate a 1 count error in 1024 (10 bit A/D) using amplitude averaging of 64 equally spaced samples over 100 msec with a sample spacing period of 1.5625 msec.
Empirical testing of a rolling average filter of 64 samples at a sample period of 1.5625 msec to reduce the random noise to 1 count in 1024 provides an adequate resolution error of 2.93 mV which is an acceleration resolution of 3.7 mg.
The rolling average filter algorithm is a subroutine which is called without input parameters and returns three 10 bit readings which are the rolling average filter values of the accelerometer's X, Y and Z axis average of 64 instantaneous samples taken over a 100 msec period.

The preferred movement and/or tilt algorithms used in this embodiment of the invention are:
Two 16 bit register sets of three registers each are maintained. They are called AVx, AVy and AVz for acceleration sample value from the accelerometer's x axis, y axis and z axis.
The rolling average filter algorithm:
   a. returns the values of the current accelerometer X, Y and Z axis samples in registers AVx0, AVy0 and AVz0,
   b. returns the results of the previous accelerometer X, Y and Z axis samples in registers AVx1, AVy1 and AVz1,
   c. returns the sum of the deviations of AVx0 and AVx1, AVy0 and AVy1 and AVz0 and AVz1 in AVΔ.
When the system is armed the user has 10 seconds to place it in the required position before movement and tilt monitoring commences.
To initialize the system before monitoring commences the rolling average sample filter algorithm is called to set up the initial acceleration values.
The 500 msec sample time is established from the RTC then the filter algorithm is called. The acceleration values in AVx0, AVy0 and AVz0 are moved to AVx1, AVy1 and AVz1 by the filter algorithm.
The rolling averaged samples of the X, Y and Z axis acceleration values are stored in AVx0, AVy0 and AVz0.
The absolute deviation between the current samples and the previous samples are divided by 2 to remove any remaining noise perturbations and are then stored in registers AVxΔ, AVyΔ and AVzΔ. The summation of the deviations is stored in AVΔ0.
The filter algorithm returns to the movement monitoring routine where the results are analyzed to determine if the system is being subjected to movement and/or tilt and the appropriate action is then taken.

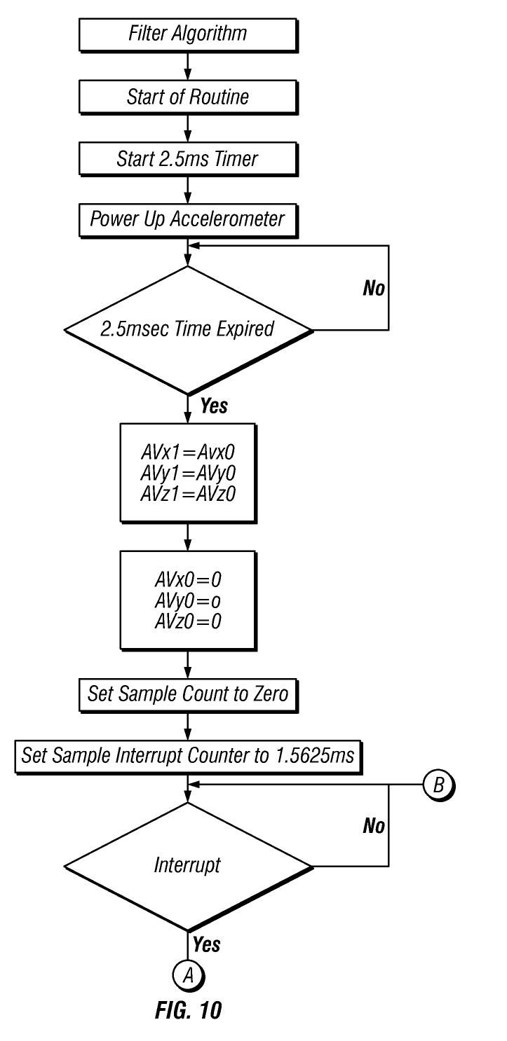

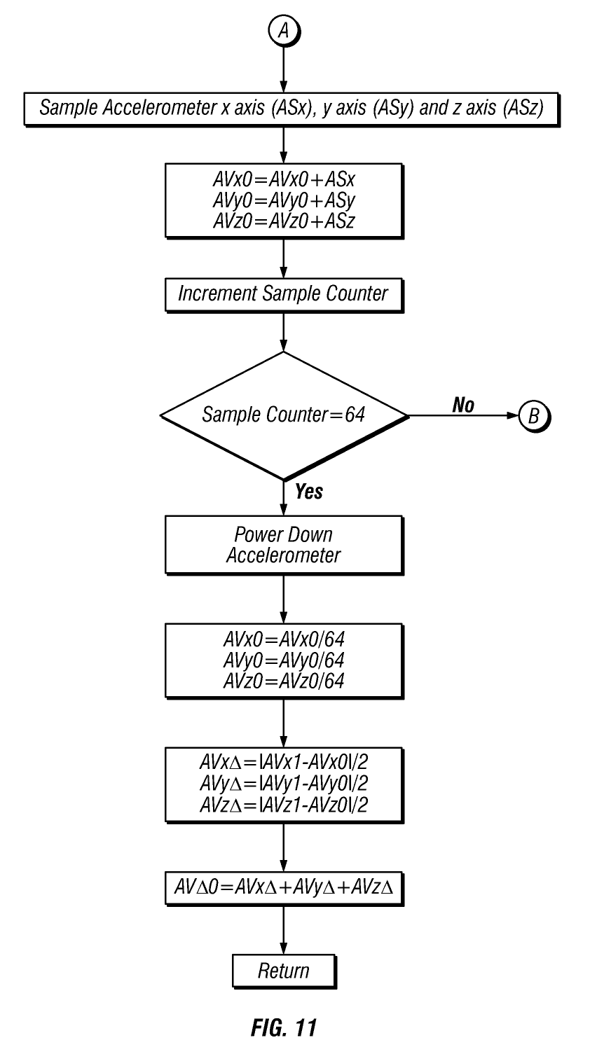

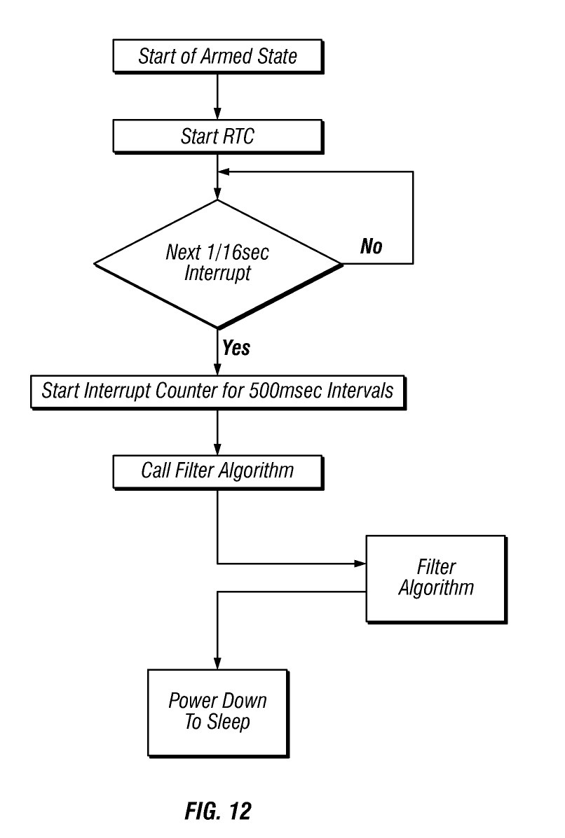

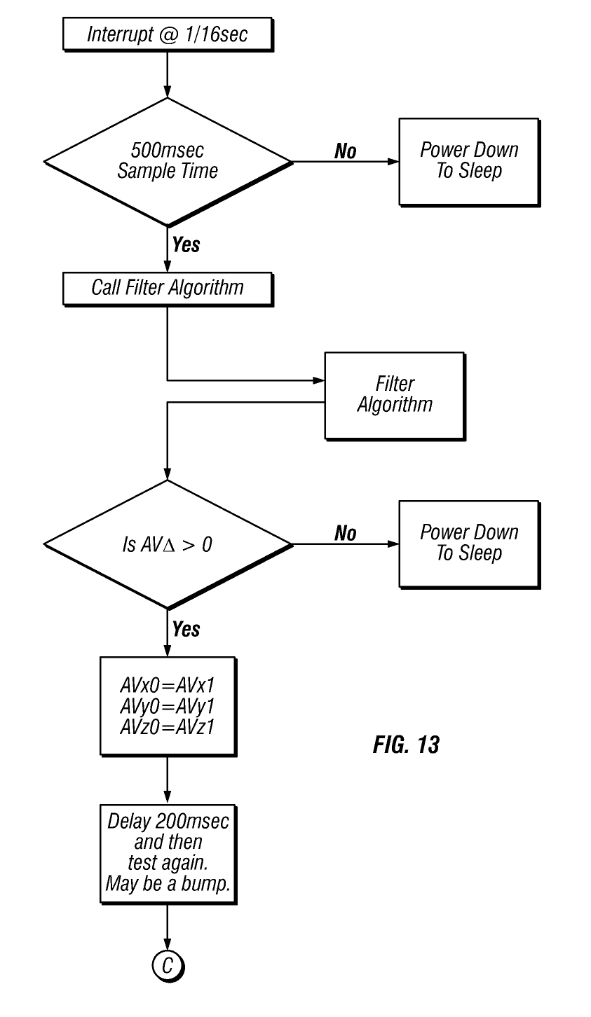

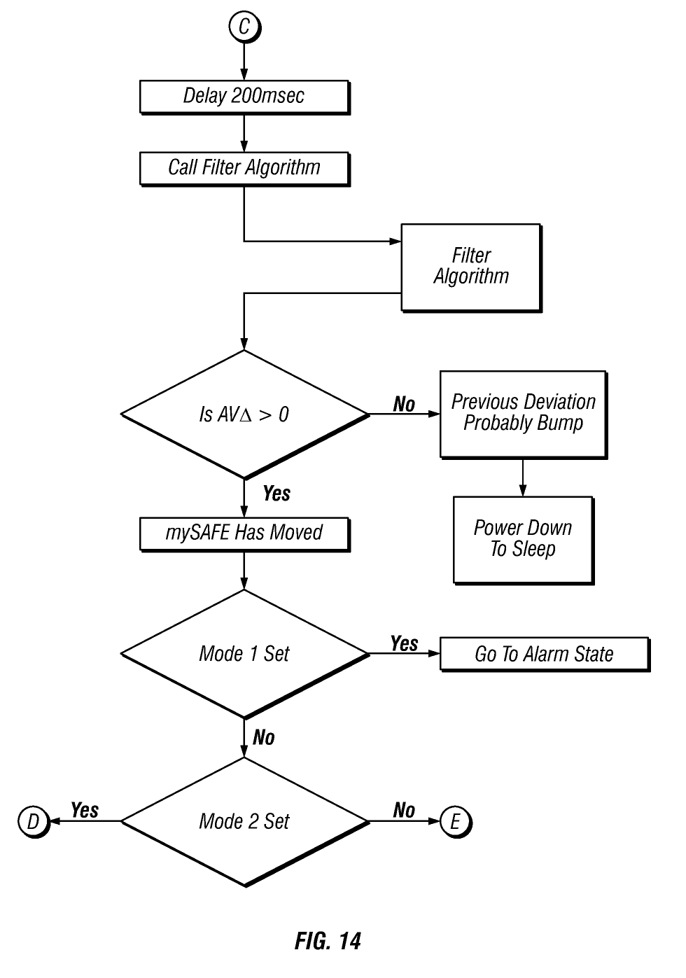

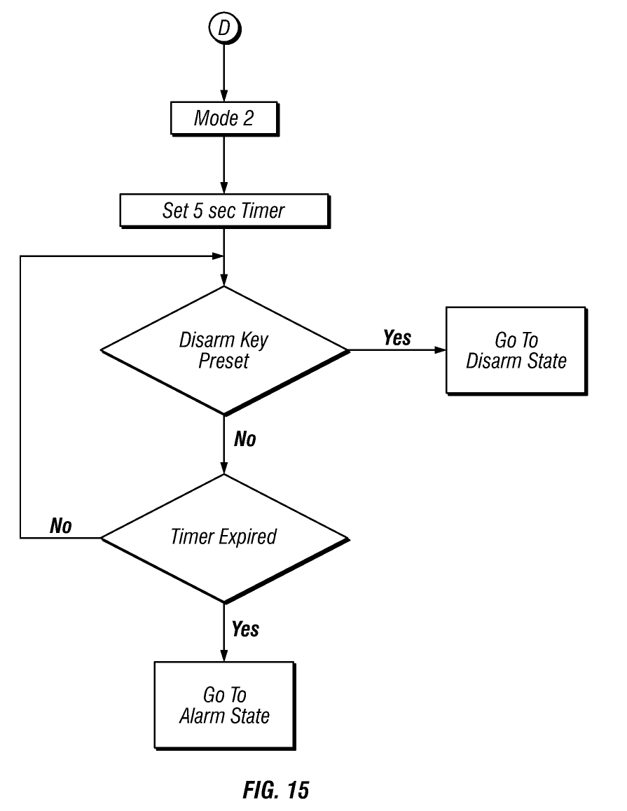

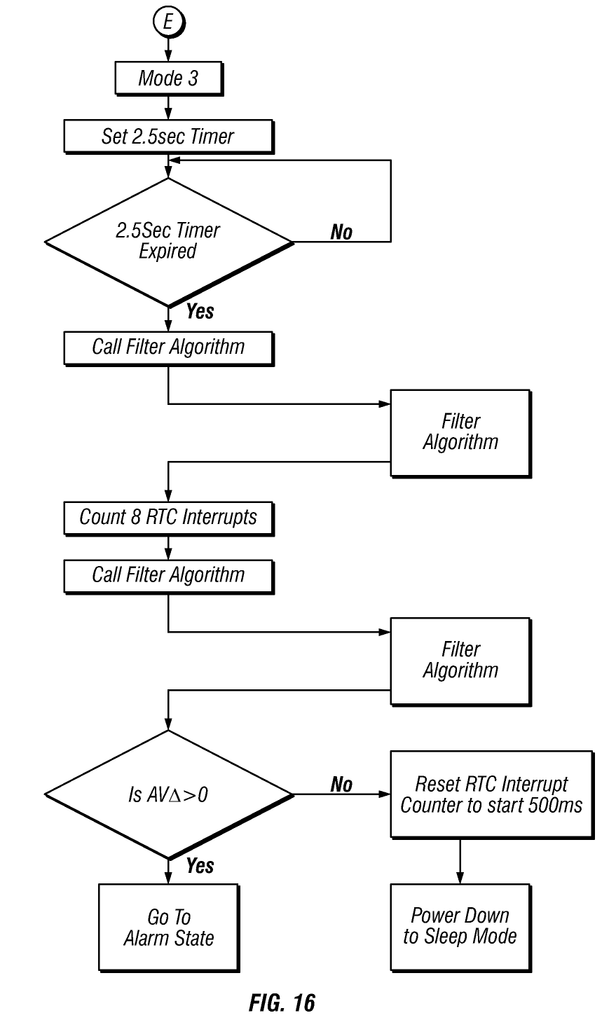

FIGS. 10 to 16 show the functional operation of this preferred embodiment of the invention in more detail.

Many of the current aspects of the invention may be powered by readily available batteries, preferably three of the AAA Alkaline type, although other primary or rechargeable batteries can be used. To maximise the battery life and thus the length of time the invention can be used before the batteries have to be replaced, a power management algorithm is preferably built into the microcontroller's firmware which minimises power usage relative to the functional state of the system.

Three AAA Alkaline batteries, when connected in series, typically provide a voltage of 4.5 volts and a capacity of approximately 1250 mAhours (mAh). By suitable arrangements of the power supply and operating the electronic subsystems at a voltage of 3.0 volts, the full capacity of 3×AAA Alkaline batteries is available to operate the electronics system of the invention. This capacity excludes the alarm system, which has its own power requirements, but is only activated by a hostile event. In that instance, gaining attention is the prime requirement and not power conservation. Because of this, the alarm system power requirements are not considered in the battery power management algorithms.

When the controller is in its Power Down state, where it is not armed and all of the electronics subsystems are switched off, the battery current drain is approximately 1 uA. With fresh batteries, this provides a standby time of approximately 1,250,000 hours or 146 years. Clearly this exceeds the physical life of a battery, so if the system is not being used, the available capacity will be limited to the batteries ‘shelf life’.

The electronic system preferably consists of a number of sub-systems which can be powered On or Off under the control of the microcontroller. Not all of the electronic sub-systems need to be active all of the time depending on the tasks required at any one time.

To extend the battery life, when the system is armed, a very low power real time clock may be used as the basic timing circuit. The controller's microcontroller can power itself down to a state where the battery power consumption is less than 1 uA. However, in this state it requires an external signal to force it to activate into an operational state. Pressing a key on the keypad provides this stimulus and allows the microcontroller to monitor and process user key entries.

The other stimulus is a very low power real time clock which can be activated by the microcontroller when it enters the Armed State. The real time clock is preferably a crystal controlled time base which generates a stimulus or interrupt to the microcontroller. In the Armed State, and before the microcontroller powers down to its very low Power Down State, it preferably disconnects the power from all of the other electronic sub-systems except for the real time clock. When the microcontroller enters the Power Down State, the system's battery requirements reduce to approximately 2 uA.

As noted before, the real time clock generates an interrupt to the microcontroller multiple times a second. The interrupt brings the microcontroller out of the Power Down State to an active Armed State and the X, Y and Z axis acceleration values from the accelerometer are measured to determine if the system has moved and if a hostile event has occurred.

As soon as the microcontroller powers up after receiving a real time clock interrupt, it applies power to the accelerometer which increases the battery current to the maximum operating level. The accelerometer requires a short period of time to stabilise after power is applied and during this time the microcontroller suspends itself to a reduced power mode. Once the accelerometer stabilisation period ends, the microcontroller powers up to full operational mode, takes the current X, Y and Z axis acceleration readings and calculates the current tilt and movement status of the system. If a hostile event has not occurred, the microcontroller disconnects power to the accelerometer and powers down to its Power Down State until the next real time clock interrupt causes the cycle to be repeated. The operational life of the batteries when the system is armed is increased significantly by the use of the power management methods incorporated in the preferred current embodiments of the system.

In a preferred current embodiment of the system, the particular electronic circuits used to form the system require amounts of battery power that may be different if different electronic circuits are used in other embodiments to achieve the same or similar power management functionality.

The foregoing description is by way of example only, and may be varied considerably without departing from the scope of the present invention. For example only, the size, shape, colour, weight and material of the container may be varied as desired. For example, the container may have a storage capacity ranging from zero to that of a standard cargo container (or more). The shape may be configured specifically for items such as laptop computers, mobile phones and MP3 players, and even traditionally non-electrical items such as handguns. When formed for use with a laptop computer, the container and/or system may be sized and configured for substantially enveloping the laptop (see, e.g., FIG. 9), or may be of reduced size and configuration so as to cover only a portion of the exterior of the laptop. The system may be incorporated into the laptop if desired. The container may be water-proof if desired (in which case one or more LEDs may be used to provide a visual alarm).

Elements of the tilt and movement detection system may be varied. For example, the placement, number, and type of alarms may be varied as desired. Examples of alarms include audio and/or visual and/or wireless to a monitoring base station. A variety of input means may be utilised. For example, the system may include a biometric reader, a magnetic reader such as a swipe card reader, manual push means such as alphanumeric keys or dials, voice activated arming, mechanical switches, mechanical lock and key, radio control, RDFI or any combination thereof.

The power supply may be self-contained and/or derived from an outside source. For example, the power supply may be battery powered with disposable or rechargeable batteries, or utilise another onboard source such as one or more solar panels. Any onboard power supply may be supplemented or replaced by an external source accessible via a power connection (e.g., a cable connection between the container and a wall outlet).

The tilt and movement detection system may be configured to measure displacement in only one plane if desired. For example, the system may be configured to measure in only the horizontal plane, or only the vertical plane, or a diagonal plane. The tilt and movement detection system may be used to lock the container in addition to or in place of a manual lock between portions of the container. For example, the keypad may be used to insert a combination to release a lock between the lid and base. The system may include one or more global positioning system (GPS) elements in place of or in addition to the accelerometer. One or more components of the system may be remotely located or controlled if desired. For example, the alarm may be separately portable and carried, for example, as a key ring with the user or report to a remote location. One or more elements of the tilt and movement detection system may be integral with the object which it is desired to protect. For example, products such as car alarms, laptop computers and cell phones may include the tilt and movement detection system such as described above as an integral component of their structure. This may involve, for example, configuring the computer electronics of the product to function as described above.

The features described with respect to one embodiment may be applied to other embodiments, or combined with or interchanged with the features other embodiments, as appropriate, without departing from the scope of the present invention.

The present invention in a preferred form provides many advantages. For example only, the dual security of a lock and a displacement measuring alarm system provides a high level of security against theft of the valuables protected by the tilt and movement detection system. The present invention in a preferred embodiment may discriminate against different types of movement in three dimensional space. The present invention in a preferred embodiment may be adapted to operate in any physical orientation equally well and provide the same level of sensitivity to the measurement of displacement of itself in all orientations. The present invention in a preferred embodiment may be adapted to measure its own tilt relative to an initial reference position by measuring the acceleration due to the earth's gravity as it is rotated around one or more of its axis in three dimensional space (X, Y and Z axes). The present invention in a preferred embodiment may be adapted to discriminate between motion caused by accidentally bumping and tilt and/or movement caused by the container moving beyond a predetermined limit. The present invention in a preferred embodiment is not required to be in a predetermined orientation.

The present invention has many applications. For example only, elements of the container and/or system may be used for portable security items such as cargo containers, vehicles such as cars, bicycles, motorcycles, and in environments such as hospitals, schools, prisons, sporting venues, and recreational areas such as beaches and parks. The container and/or system may be sized and configured for use with a handgun if desired. If used with a handgun, the system may be incorporated with a handgun lock, for example, around the trigger area. The container and/or system may be attached to or incorporated into suitcases, backpacks or other luggage carrying products if desired. As will be appreciated, many other applications are available.

Other configurations for detection are possible and disclosed in U.S. application Ser. No. 12/536,902, filed Aug. 6, 2009, entitled “Portable Security Container with Movement Detection System,” the entire contents of which is incorporated by reference herein.

It will of course be realised that the above has been given only by way of illustrative example of the invention and that all such modifications and variations thereto as would be apparent to persons skilled in the art are deemed to fall within the broad scope and ambit of the invention as herein set forth.

What is claimed is:

1. An alarm system, comprising:
an accelerometer adapted to detect acceleration of an object along three axes;
a controller adapted to determine a change in a gravity vector of said object from a reference point based on acceleration of said object due to gravity; and
an alarm adapted to transmit a signal upon a change in the gravity vector of said object as determined by said controller.

2. The system of claim 1, wherein said controller is adapted to determine an angular change of the gravity vector.

3. The system of claim 1, wherein said controller is adapted to determine a change in magnitude of the gravity vector.

4. The system of claim 1, further comprising an electronic low pass filter to reduce background noise between the accelerometer and the controller.

5. The system of claim 1, further comprising a rolling average filter to reduce background noise between the accelerometer and the controller.

6. The system of claim 1, wherein said controller is adapted to determine a change in acceleration of the object in addition to any acceleration due to gravity.

7. A container, comprising:
a body having a storage compartment; and
a tilt and movement detection system having an accelerometer, a controller adapted to determine a change in a gravity vector of said body from a reference point based on acceleration of said body due to gravity, and an alarm adapted to transmit a signal when said controller has determined a change in the gravity vector of said body.

8. The container of claim 7, wherein said controller is adapted to determine an angular change of the gravity vector.

9. The container of claim 7, wherein said controller is adapted to determine a change in magnitude of the gravity vector.

10. The container of claim 7, further comprising an electronic low pass filter to reduce background noise between the accelerometer and the controller.

11. The container of claim 7, further comprising a rolling average filter to reduce background noise between the accelerometer and the controller.

12. The container of claim 7, wherein said controller is adapted to determine a change in acceleration of said body in addition to any acceleration due to gravity.

13. A method for alerting a person to movement of an object from a reference position, comprising:
measuring acceleration of the object due to gravity to determine a first measurement;
re-measuring acceleration of the object due to gravity after a pre-selected time interval to determine a second measurement;
comparing the first and second measurements; and
producing a signal if the measurements are different.

14. The method of claim 13, wherein the step of comparing includes determining a gravity vector.

15. The method of claim 14, wherein the step of producing the signal includes producing the signal upon detection of an angular change in the gravity vector.

16. The method of claim 14, wherein the step of producing the signal includes producing the signal upon detection of a change in the magnitude of the gravity vector.

17. The method of claim 13, further comprising utilising an electronic low pass filter to decrease background noise.

18. The method of claim 13, further comprising utilising a rolling average filter to decrease background noise.

19. The method of claim 13, further comprising measuring a change in acceleration of the object apart from any acceleration due to gravity, and using the measurement thus obtained with the measurement of the acceleration of the object due to gravity to determine the first measurement.

20. The method of claim 13, further comprising at least one of the following:
measuring the yaw and/or pitch and/or roll with a gyroscope;
measuring position relative to the earth's magnetic field with a magnetometer.
